(19) United States
(12) Patent Application Publication
(10) Pub. No.: US 2002/0092214 A1
(43) Pub. Date: Jul. 18, 2002

(54) Greeting card

(76) Inventor: George W. Girdler, Simonton, TX (US)

Correspondence Address: Richard L. Moseley, P.O. Box 630708, Houston, TX, 77263, US

(21) Appl. No.: 09/760,143

(22) Filed: Jan. 16, 2001

(51) Int. Cl. G09F 1/00

(52) U.S. Cl. 40/124.06; 283/117

(57) ABSTRACT

A greeting card having adhesive on one surface and a jigsaw puzzle like card for releasable attachment to the adhesive. The pieces of the jigsaw puzzle are contained in a pouch attached to one edge of the card. A non-stick sheet is provided to prevent inner surfaces for sticking together.

### BACKGROUND OF THE INVENTION

1. Field of the Invention

The present invention relates to greeting cards. More particularly the invention relates to a greeting card having adhesive applied to one surface to which a jig saw puzzle like card may be assembled and attached to reveal a message or picture.

### SUMMARY OF THE INVENTION

In its simplest form the present invention comprises

(a) a substantially rectangular first sheet folded to form a card having at least four surfaces comprising a front surface, two opposed inner surfaces and a back surface, each of said surfaces having a top edge, a bottom edge, and two side edges;

(b) an adhesive applied to one of said inner surfaces;

(c) a non-stick second sheet connected to one edge of one of said inner surfaces and disposed between said inner surfaces to prevent said surfaces from adhering to each other;

(d) a card cut into randomly shaped pieces for assembly and attachment to said adhesive; and

(e) a resealable container attached to said card for containing said randomly shaped pieces.

### BRIEF DESCRIPTION OF THE DRAWING

FIG. 1 is an isometric view of one embodiment of the invention.

FIG. 2 is an isometric view of a second embodiment of the invention.

FIG. 3. is a plan view of an insert card for attaching to the greeting card of the present invention.

### DETAILED DESCRIPTION OF THE PREFERRED EMBODIMENT

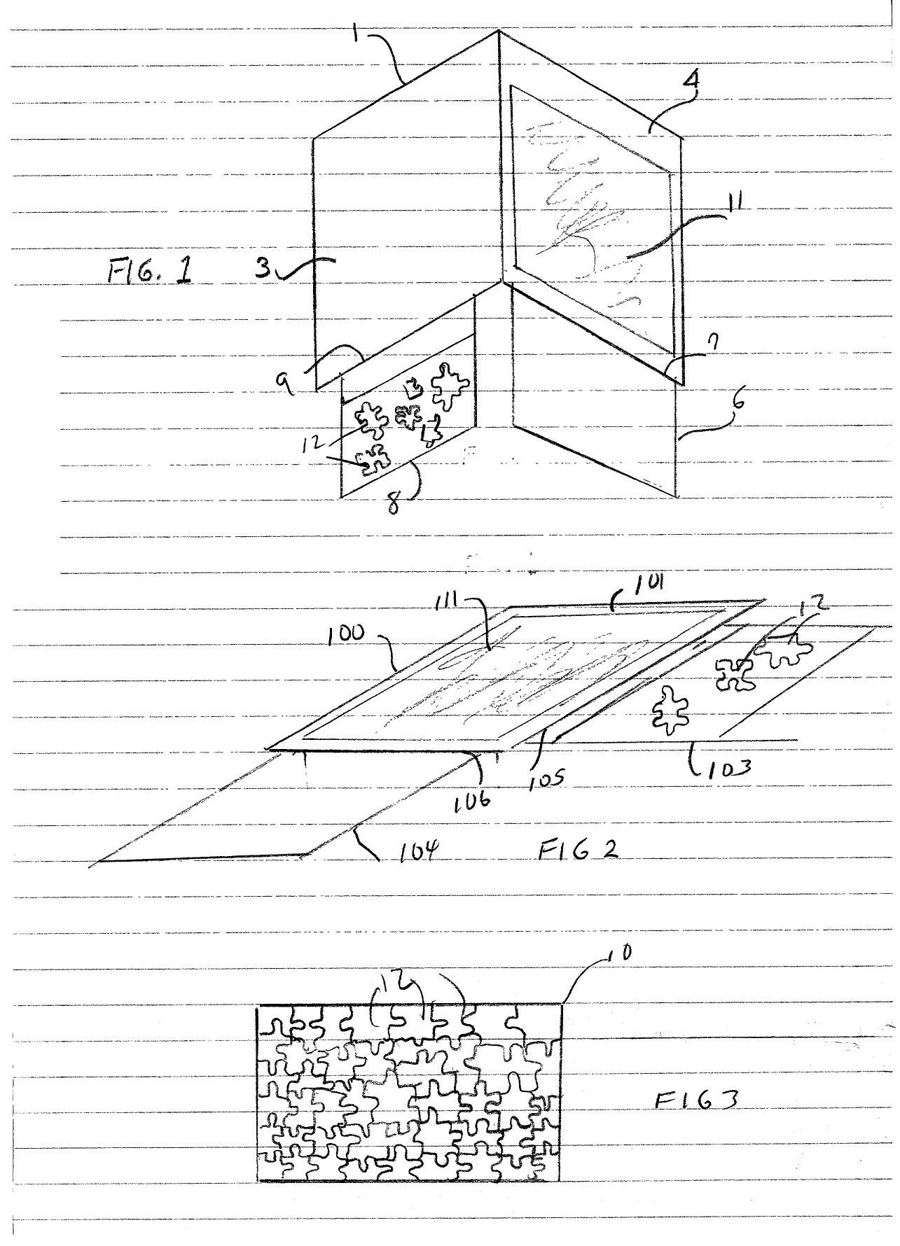

Referring now to FIG. 1. the greeting card of the present invention comprises a single sheet of suitable paper 1 folded at least once to create a card having a first inner surface 3, and a second inner surface 4 directly opposite the first face. Adhesive 11 is applied to one of said inner surfaces, here shown to be surface 4. A non-stick sheet 6 as of wax paper is attached to the bottom edge 7 of inner surface 4 to be folded over and between the two inner surfaces 3 and 4 to prevent them from adhering together. A resealable container such as a bag or pouch 8 is attached to another edge 9 of one of the inner surfaces to hold pieces 12 of an insert card 10 shown in FIG. 3 which are randomly cut in jig saw puzzle fashion. The insert card is designed to removably adhere to the adhesive to allow assembly of the jig saw puzzle onto inner surface 4.

The insert card can have on its face any picture or message desired by the manufacturer or sender. For instance a picture made by the sender may be cut into random pieces and the receiver assembles the “jig saw” puzzle onto the adhesive to complete the greeting.

Referring now to FIG. 2 a simple greeting card is shown. In this embodiment a single unfolded sheet 100 having only two surfaces, a front 101 and a back (unseen) is used. The adhesive 111 is applied to one of the surfaces such as the front 101 and the pouch 103 containing the pieces 12 of the card 10 and non-stick sheet 104 being attached to edges 105 and 106 respectively

While it is anticipated that the single sheet (folded or unfolded) be rectangular, the invention is not so limited. The shape of the final card could be any fanciful shape to reflect the seasonal nature of the greeting, i.e., a heart for Valentine's Day, a bell for Christmas, etc.

The invention claimed is:

1. A greeting card comprising:
(a) a sheet having at least two surfaces
(b) an adhesive applied to one of said surfaces; and
(c) a card cut into randomly shaped pieces for assembly and attachment to said adhesive.

2. The greeting card according claim 1 further comprising a resealable container attached to said card for containing said randomly shaped pieces.

3. A greeting card comprising:
(a) a substantially rectangular first sheet folded to form a card having at least four surfaces comprising a front surface, two opposed inner surfaces and a back surface, each of said surfaces having a top edge, a bottom edge, and two side edges;
(b) an adhesive applied to one of said inner surfaces;
(c) a non-stick second sheet disposed between said inner surfaces to prevent said surfaces from adhering to each other; and
(d) a card cut into randomly shaped pieces for assembly and attachment to said adhesive.

4. The greeting card according claim 3 further comprising a resealable container attached to said card for containing said randomly shaped pieces.

5. The greeting card according to claim 3 wherein said substantially rectangular sheet is trimmed after folding into a miscellaneous shape connected at the fold.

6. The greeting card according to claim 3 wherein said non-stick second sheet is connected to one edge of one of said inner surfaces.

7. A greeting card comprising:
(a) a substantially rectangular first sheet folded to form a card having at least four surfaces comprising a front surface, two opposed inner surfaces and a back surface, each of said surfaces having a top edge, a bottom edge, and two side edges;
(b) an adhesive applied to one of said inner surfaces;
(c) a non-stick second sheet connected to one edge of one of said inner surfaces and disposed between said inner surfaces to prevent said surfaces from adhering to each other;
(d) a card cut into randomly shaped pieces for assembly and attachment to said adhesive; and
(e) a resealable container attached to said card for containing said randomly shaped pieces.
